(19) United States
(12) Patent Application Publication
(10) Pub. No.: US 2013/0168382 A1
(43) Pub. Date: Jul. 4, 2013

(54) PLANAR HEATING BODY

(71) Applicants: Takerou Teramoto, Kanazawa (JP); Hidekazu Shirasawa, Kahoku (JP); Daigo Kakiuchi, Kahoku (JP); Yuusuke Yamada, Takaoka (JP)

(72) Inventors: Takerou Teramoto, Kanazawa (JP); Hidekazu Shirasawa, Kahoku (JP); Daigo Kakiuchi, Kahoku (JP); Yuusuke Yamada, Takaoka (JP)

(73) Assignee: HOKURIKU S.T.R. COOPERATIVE, Oyabe-shi, Toyama (JP)

(21) Appl. No.: 13/823,493

(22) PCT Filed: May 11, 2012
(86) PCT No.: PCT/JP2012/062178

§ 371 Date: Mar. 14, 2013

(30) Foreign Application Priority Data
May 20, 2011 (JP) 2011-113083

(51) Int. Cl. H05B 3/34

(52) U.S. Cl. CPC H05B 3/345
USPC 219/529; 219/545

(57) ABSTRACT

Provided is a planar heating body characterized by comprising: a knitted structure; a plurality of first heating threads which are laterally woven with a space therebetween in the longitudinal direction in the knitted structure; and a plurality of conducting threads which are longitudinally woven in edge sections at both sides of the knitted structure in the lateral direction.

### TECHNICAL FIELD

The present invention relates to a planar heating body to generate heat by energizing.

### BACKGROUND ART

PTL 1 discloses a planar heating body to be embedded into a vehicular sheet. The planar heating body is provided with a fabric member, a plurality of heating wires mounted to the fabric member in a parallel manner, and an energizing unit mounted to an edge section on either side of the fabric member by adhering or sewing. The heating wire is made of a carbon fiber as a core portion and a covering yarn twined with the carbon fiber. PTL 1 shows, as the above fabric member, a woven fabric (example 1), a knit fabric (example 2) and a lace (examples 3, 4).

### CITATION LIST

### Patent Literature

[PTL 1] JP 2010-218813 A

### SUMMARY OF INVENTION

### Technical Problem

With respect to the planar heating body according to the PTL 1, the fabric member is prepared, and thereafter the energizing unit is mounted to the fabric member by the adhering or sewing. Therefore, preparing of the planar heating body takes time and effort. Further, when the planar heating body is frequently used, the energizing unit may be removed or deviated from the fabric member. Further, when the heating wire breaks, a low temperature portion may be caused across the entire width of the fabric member.

The present invention has been made in view of the above problems. It is an object of the present invention to provide a planar heating body excellent in productivity and durability.

### Solution to Problem

According to an aspect of the present invention, there is provided a planar heating body comprising: a knit structure; a plurality of first heating yarns knitted into the knit structure in a lateral direction at intervals in a longitudinal direction; and a plurality of conductive yarns knitted into an edge section on each of both sides of the knit structure in the lateral direction, the conductive yarns being knitted thereinto in the longitudinal direction.

The planar heating body may further comprise: a plurality of second heating yarns knitted in the longitudinal direction in such a manner as to intersect with the first heating yarns.

The first heating yarns and the second heating yarns may be so knitted in a form of a net as to have voids between the first heating yarns and the second heating yarns.

The first heating yarns and the second heating yarns may be made of a pitch-based carbon fiber having a resistance of 50 Ω/m to 1000 Ω/m.

The planar heating body may further comprise: a sheet made of a resin or a rubber, the sheet covering an entirety of the knit structure and.

### Advantageous Effects of Invention

According to the present invention, it is possible to provide a planar heating body excellent in productivity and durability.

### BRIEF DESCRIPTION OF DRAWINGS

FIG. 1 is a plan view schematically showing a planar heating body according to one embodiment of the present invention.

FIG. 2 is an enlarged plan view of a heating ground fabric constituting the planar heating body shown in FIG. 1.

FIG. 3 is a plan view showing apart of the heating ground fabric shown in FIG. 2, by further enlarging the same.

FIG. 4 is a plan view showing a structure constituting the heating ground fabric shown in FIG. 2, by individually separating the same.

FIG. 5 is a side view showing a heating yarn according to the one embodiment of the present invention, by enlarging the same.

FIG. 6 is a graph showing changes of the surface temperature of a protective sheet in the planar heating body according to the one embodiment of the present invention.

FIG. 7 is a table showing results of measuring the current, power consumption, resistance and temperature when a voltage is applied, where the measurement is implemented on the heating yarns using carbon fibers having different resistance per unit length.

FIG. 8 is a graph showing the power consumption relative to the surface temperature obtained from the measurement results in FIG. 7.

### DESCRIPTION OF EMBODIMENTS

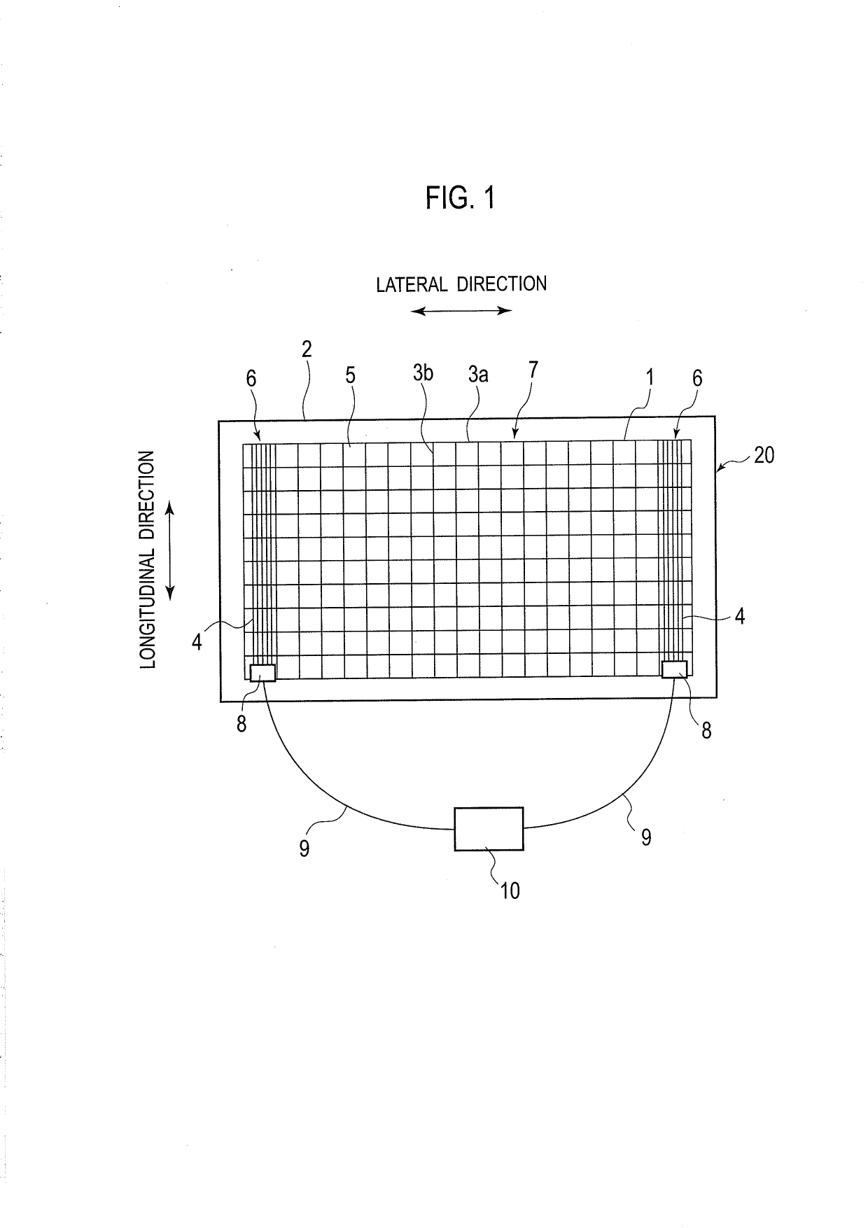

Hereinafter, an embodiment of the present invention will be described based on drawings. FIG. 1 shows a planar heating body 20 according to an embodiment of the present invention. The planar heating body 20 includes: a heating ground fabric 1 having a net-shaped knit structure (knit fabric), and a protective sheet 2 covering the entirety of the heating ground fabric 1. A plurality of heating yarns (first heating yarns) 3a are knitted into the heating ground fabric 1 in a lateral direction (weft direction) at predetermined intervals in a longitudinal direction (warp direction). Further, a plurality of heating yarns (second heating yarns) 3b are knitted into the heating ground fabric 1 in the longitudinal direction (warp direction) at predetermined intervals in the lateral direction (weft direction) in such a manner as to intersect with the heating yarns 3a. The above predetermined intervals are each, for example, 2 cm to 4 cm. However, these values do not limit the present invention. Specifically, the heating yarns 3a and the heating yarns 3b are knitted into the heating ground fabric 1 in a form of a grid (net) such that a plurality of voids 5, each having a length of 2 cm to 4 cm, are formed in the longitudinal and lateral directions. Each of the heating yarns 3a, 3b is made of carbon fibers and is a conductor (resistor) having a predetermined resistance. Thus, as described in detail later, the current, flowing through the heating yarns 3a, 3b, heats the heating yarns 3a, 3b, resulting in heating of the whole surface of the heating ground fabric 1.

The heating ground fabric 1 will be explained in detail.

The heating ground fabric 1 according to the present embodiment is a knit texture (knit fabric), and is knitted by a Raschel knitting machine, for example. Though not limited by the present invention, the knit gauge of the Raschel knitting machine is 12 G (gauge)/inch (12 needles/inch), for example. Further, though not limited by the present invention, the knitting counts in the knitting of the heating ground fabric 1 is 22 counts/inch, for example. That is, under the above counts in the knitting, 22 meshes (loops) are knitted per inch along the longitudinal direction during the knitting.

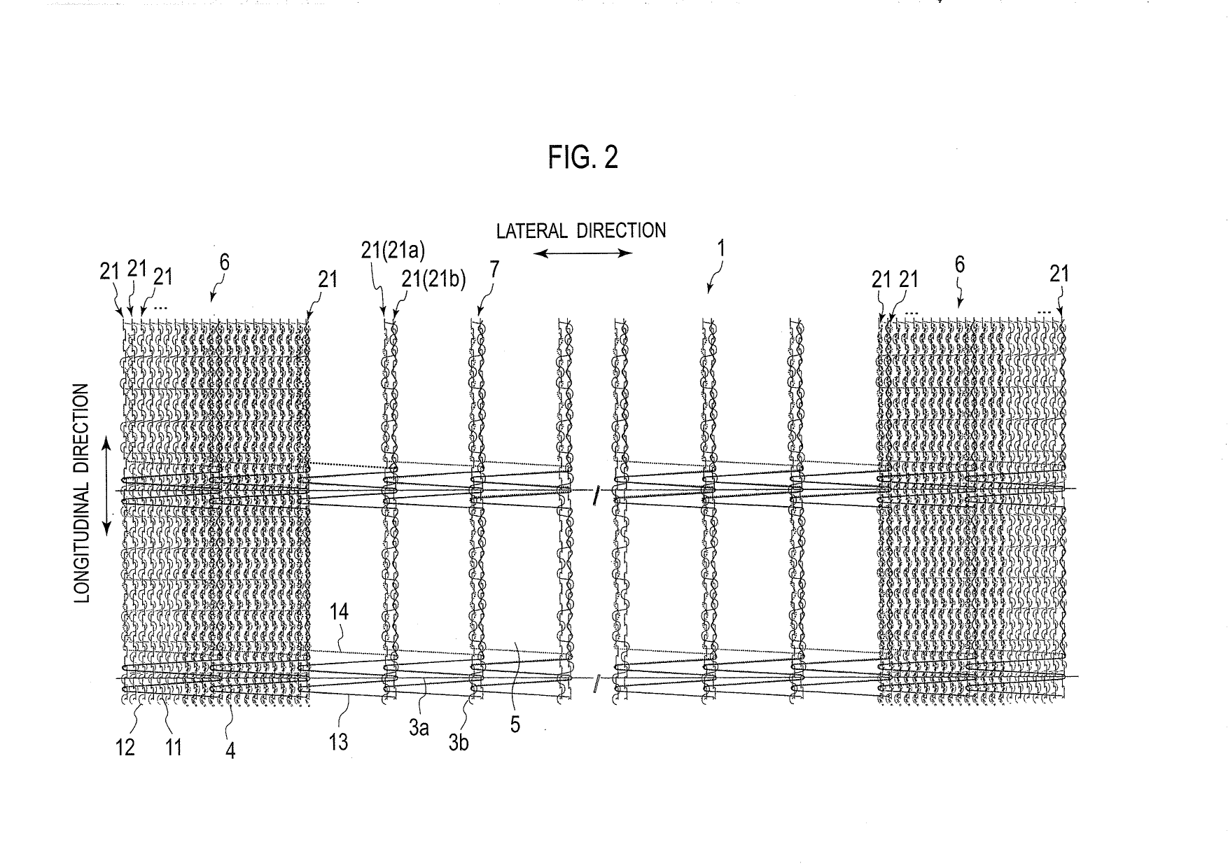

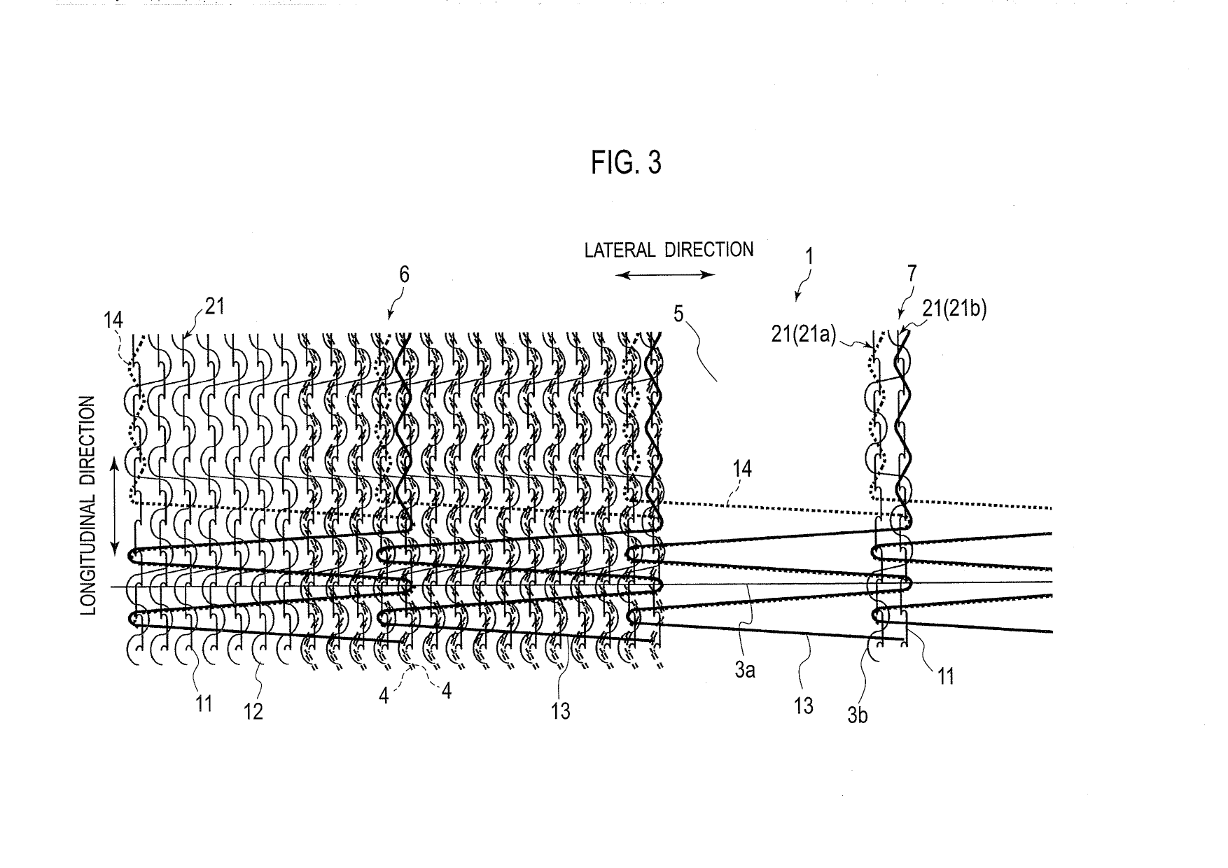

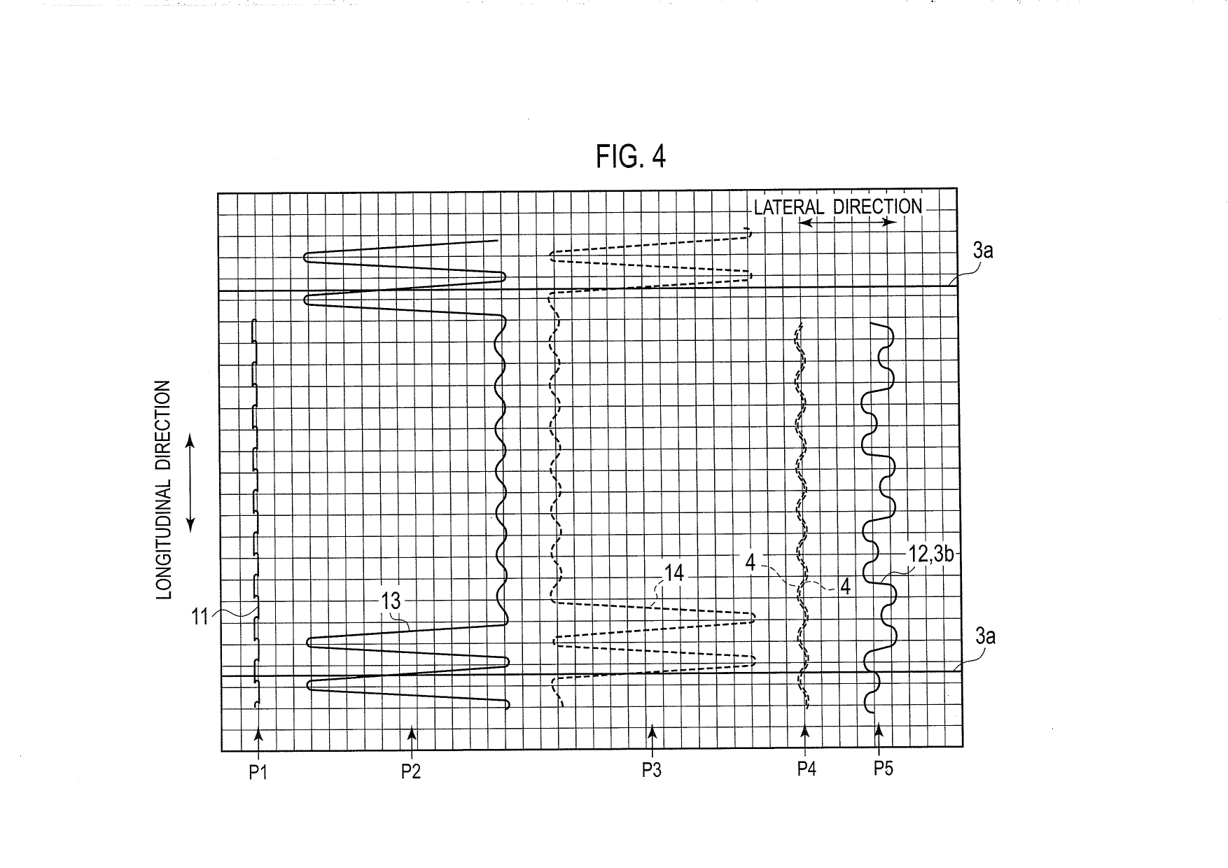

The heating ground fabric 1 has a mesh portion 7 and edge sections 6, 6 provided on respective sides of the mesh portion 7 in the lateral direction. First, the edge section 6 will be explained. As shown in FIG. 2 and FIG. 3, the edge section 6 is knitted by a ground yarn 11, an insert yarn 12 and a conductive yarn 4. Herein, the ground yarn 11 and the insert yarn 12 each are cotton yarns, for example. The conductive yarn 4 is a copper strip (copper wire), for example. Specifically, a plurality of chain stitches 21 of the ground yarn 11 are knitted and the insert yarn 12 is knitted into the plurality of chain stitches 21 in a zigzag form to thereby connect the chain stitches 21 with each other, and the conductive yarn 4 is knitted into at least one of the plurality of chain stitches 21. Further, as shown in FIG. 2, the insert yarns 13, 14 and heating yarn 3a, which constitute the mesh portion 7, are knitted into the edge section 6 along the longitudinal direction at the above predetermined intervals. Herein, the insert yarns 13, 14 are a cotton yarn, for example. The chain stitch 21 is knitted according to a knit pattern P1 shown in FIG. 4, for example. Further, the insert yarn 12 is knitted according to a knit pattern P5 shown in FIG. 4, for example. Further, the ground yarn 11 and the insert yarn 12 each may be knitted according to other pattern(s). Though the number of chain stitches 21 may be determined arbitrarily, each of the edge sections 6 according to the embodiment has 22 wales of chain stitches 21 as shown in FIG. 3, for example.

Further, a plurality of conductive yarns 4 are knitted into the edge section 6 in the longitudinal direction. Specifically, the conductive yarn 4 is knitted in a zigzag form into each of the plurality of chain stitches 21 positioned on the mesh portion 7 side in the edge section 6. The conductive yarn 4 is knitted into the chain stitch 21 according to a knit pattern P4 shown in FIG. 4, for example. The conductive yarn 4 is electrically connected with the heating yarn 3a inserted into the edge section 6, and thus the conductive yarn 4 plays a role as a supply route of an electric current to the heating yarn 3a. For the above purpose, the conductive yarn 4 is made of a highly-conductive metal such as, copper or an alloy.

Further, as long as the desired mechanic characteristics and electrical characteristics are satisfied, the number of conductive yarns 4 knitted into each of the chain stitches 21 is determined arbitrarily. For example, in the present embodiment, as shown in FIG. 3, two conductive yarns 4 are knitted in parallel with each other per wale of the chain stitch 21. Further, as long as the desired mechanic characteristics and electrical characteristics are satisfied, the number (wale) of chain stitches 21 into which the conductive yarns 4 is knitted is determined arbitrarily. For example, in the present embodiment, as shown in FIG. 3, the conductive yarn 4 is knitted into each of 15 wales of chain stitches 21 when viewed from the mesh portion 7 side. Thus, in the present embodiment, a total of 30 conductive yarns 4 are to be knitted into the edge section 6.

A terminal 8 is attached to one end portion of each of the edge sections 6 in the longitudinal direction. The terminal 8 is electrically connected with the conductive yarn 4. Further, a lead wire 9 is connected to the terminal 8 of each of the edge sections 6, and the lead wire 9 is connected to an output of a power supply 10. Thus, the current flows from the power supply 10 to the heating yarns 3a, 3b by way of the lead wire 9, the terminal 8 and the conductive yarn 4. Further, the output current of the power supply 10 may be a direct current or an alternating current. Further, the driving power for the power supply 10 may be a direct current or an alternating current. For example, the power supply 10 may be operated by a commercial power or by a battery.

Next, the mesh portion 7 will be explained. The mesh portion 7 is knitted in a form of a grid (net) by the ground yarn 11, the insert yarns 13, 14 and the heating yarn 3b. The ground yarn 11 is knitted into a plurality of sets of chain stitches 21 at the above predetermined intervals. The heating yarn 3b is knitted into the chain stitches 21 of each set along the longitudinal direction in a zigzag manner so as to be knitted across a gap therebetween. The heating yarn 3b binds the chain stitches 21, and functions as a heating element same as the heating yarn 3a. Further, the insert yarns 13, 14 link the sets of the chain stitches along the lateral direction, and prevent the relative deviation between the sets of chain stitches 21 and the heating yarns 3b.

With the mesh portion 7 according to the present embodiment, a plurality of paired chain stitches 21, 21 (chain stitches 21a, 21b in FIG. 3) are knitted at a gap of 8 wales. In other words, the knitting of the chain stitches 21 using the ground yarns 11 is repeated by predetermined cycles with 8 outs/2 ins. That is to say, with respect to forming of the chain stitches 21, (a) 22 wales of chain stitches 21 are knitted to form one of the edge sections 6, (b) the knitting of the chain stitches 21 is repeated, for example, 38 times with 8 outs/2 ins to form the mesh portion 7, and the knitting is further skipped by 8 needles, and (c) 22 wales of chain stitches 21 are knitted to form the other of the edge sections 6.

As shown in FIG. 3, the pair of the left chain stitch 21 and the right chain stitch 21 are denoted by 21a and 21b, respectively. The insert yarn 13 is knitted based on a knitting pattern P2 (refer to FIG. 4), for example. Specifically, when the chain stitch 21b is supposed as a reference point, the insert yarn 13 is twice shogged back and forth from the chain stitch 21b by 12 wales (needles) as one way with striding over the chain stitch 21a, and thereafter the insert yarn 13 is knitted into the chain stitch 21b by 15 courses along the longitudinal direction in a zigzag manner. A knit pattern P3 (refer to FIG. 4) of the insert yarn 14 is a reversed pattern of the knit pattern P2 of the insert yarn 13. Specifically, when the chain stitch 21a is supposed as a reference point, the insert yarn 14 is twice shogged back and forth from the chain stitch 21a by 12 wales (needles) as one way with striding over the chain stitch 21b, and thereafter the insert yarn 14 is knitted into the chain stitch 21a by 15 courses along the longitudinal direction in a zigzag manner. As described above, the insert yarn 13 and insert yarn 14 are knitted in the knit patterns reversed relative to each other, thereby the one set of chain stitches 21a, 21b receive a substantially equal tensional force from left and right in the lateral direction. Thus, a relative deviation of the chain stitches 21 in the mesh portion 7 can be suppressed, thus enabling to have the mesh portion 7 firmly maintain the whole shape as a grid (net) having the voids 5. Further, as shown in FIG. 3, the insert yarn 13 and the insert yarn 14 may be knitted into the edge section 6 based on the knit patterns P2, P3, respectively.

Further, the heating yarn 3a is inserted into the mesh portion 7 in the lateral direction. Specifically, the heating yarn 3a is inserted into the position where the insert yarn 13 or insert yarn 14 strides over between two sets of chain stitches 21. For example, as shown in FIG. 3, the heating yarn 3a is inserted across the entire width of the heating ground fabric 1 when the insert yarn 13 returns rightward by 12 wales after moving leftward by 12 wales. In the present the embodiment, the heating yarn 3a is inserted corresponding to the inserting of the insert yarn 13 or insert yarn 14, so that the heating yarn 3a is inserted every 18 courses.

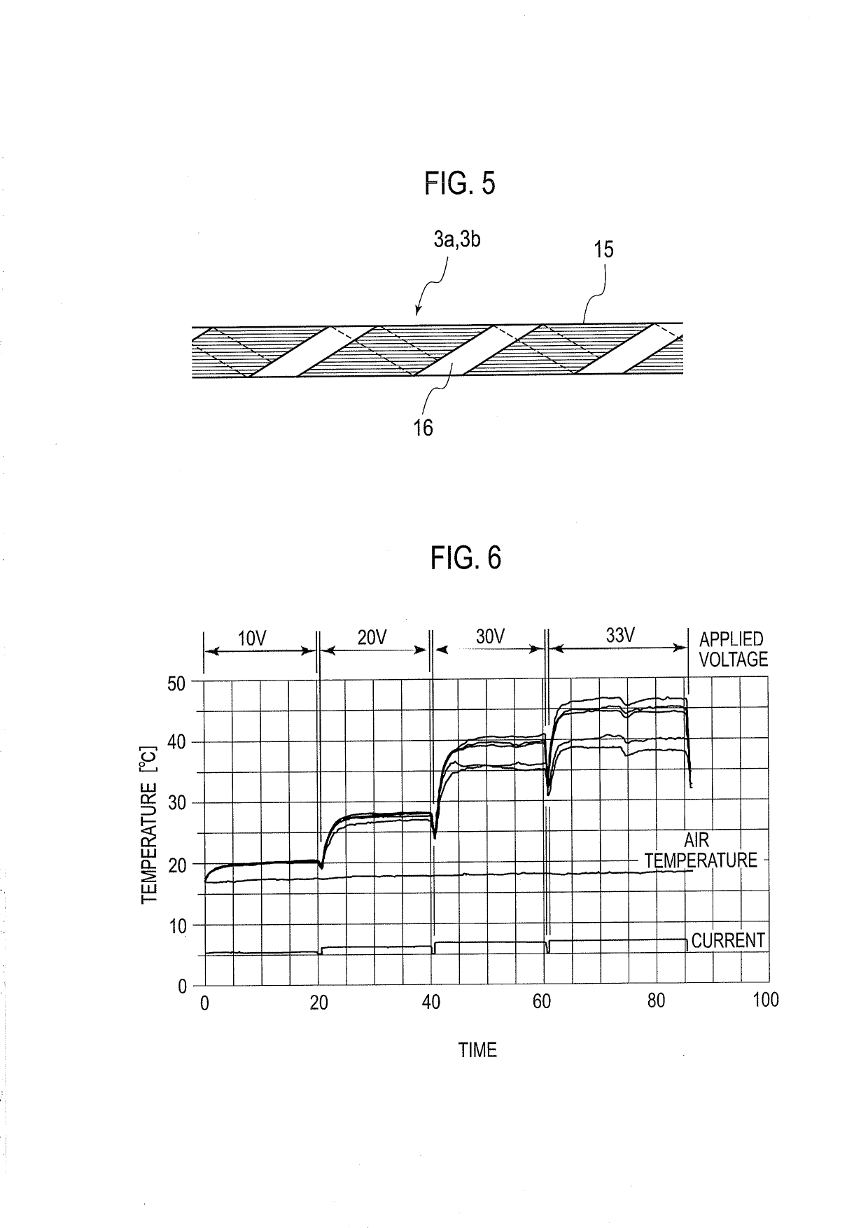

The heating yarns 3a, 3b each include a bundle of pitch-based carbon fibers 15 and an aramid fiber 16. For example, as shown in FIG. 5, each of the heating yarns 3a, 3b is formed by spirally winding the aramid fiber 16 around an outer periphery of the bundle of the carbon fibers 15. In other words, each of the heating yarns 3a, 3b is formed by twining the bundle of the carbon fibers 15 with the aramid fiber 16. One heating yarn 3a (3b) includes about 1000 carbon fibers 15. Though not being limited by the present invention, resistance of the heating yarns 3a, 3b is 300 Ω/m, for example.

As described above, the protective sheet 2 is a flexible film or sheet, which covers the entirety of the heating ground fabric 1. The protective sheet 2 has electrical insulation and heat durability. The protective films 2 adhere to front and back surfaces of the heating ground fabric 1 so as to sandwich the heating ground fabric 1. This is made by lamination, for example. A material of the protective sheet 2 is a resin such as PET (polyethylene terephthalate) and the like, or an elastomer such as rubber and the like. When the PET film is used as the protective sheet 2, the thickness thereof is 0.1 mm, for example. When a natural rubber sheet is used as the protective sheet 2, the thickness thereof is 1 mm, for example. Further, in the present invention, the protective sheet 2 is not necessarily required. Therefore, it is possible to use the heating ground fabric 1 with being exposed outwardly.

FIG. 6 shows changes of the surface temperature of the protective sheet 2 when voltages of 10 V, 20 V, 30 V and 33 V are applied to the heating yarn 3a (3b). In this measurement, the alternating current flowed through the heating yarn 3a (3b) at an air temperature of 17° C. The length of the heating yarn 3a (3b) was 900 mm. As shown in FIG. 6, when the voltage applied to the heating yarn 3a (3b) was changed, its surface temperature rapidly changed. The surface temperature rapidly increased corresponding to the increase in the applied voltage. For example, when a voltage of 33 V is applied, the surface temperature of the heating yarn 3a (3b) and the planar heating body 20 was about 46° C.

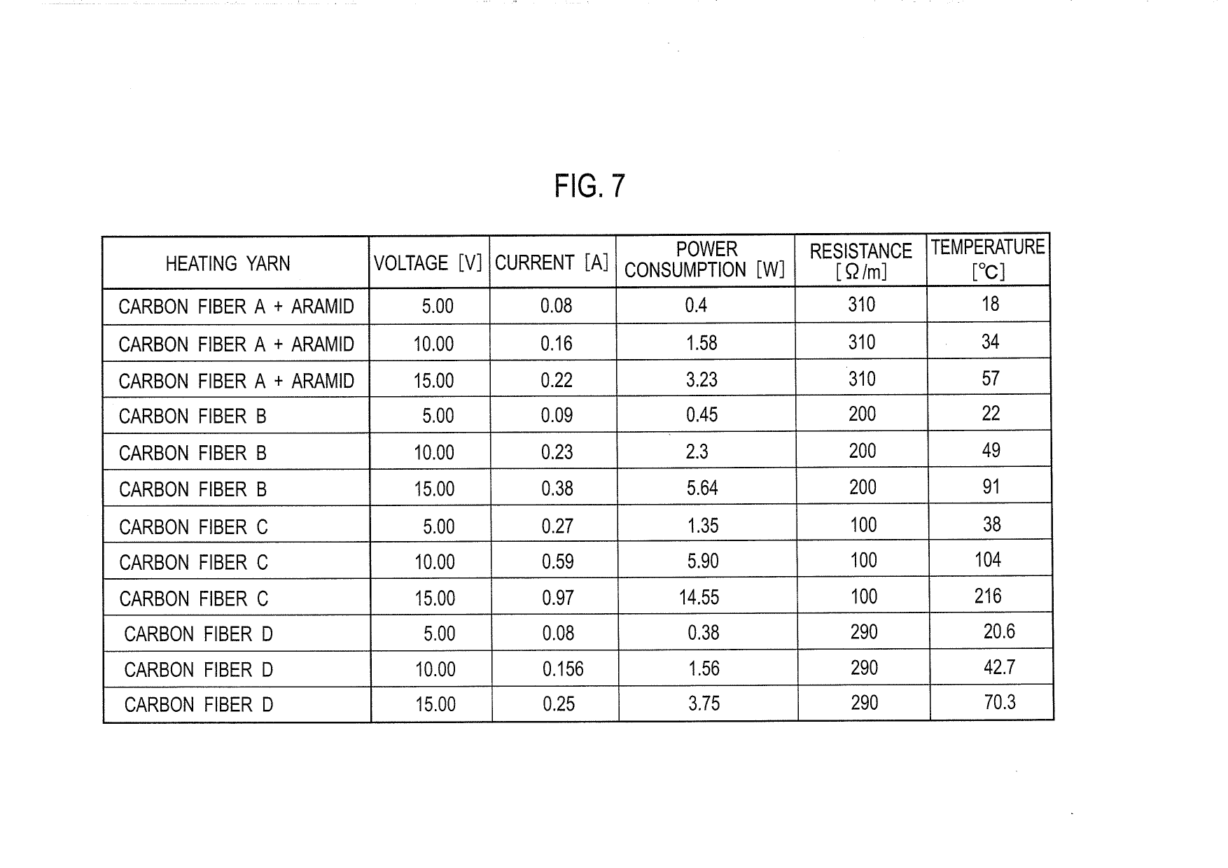

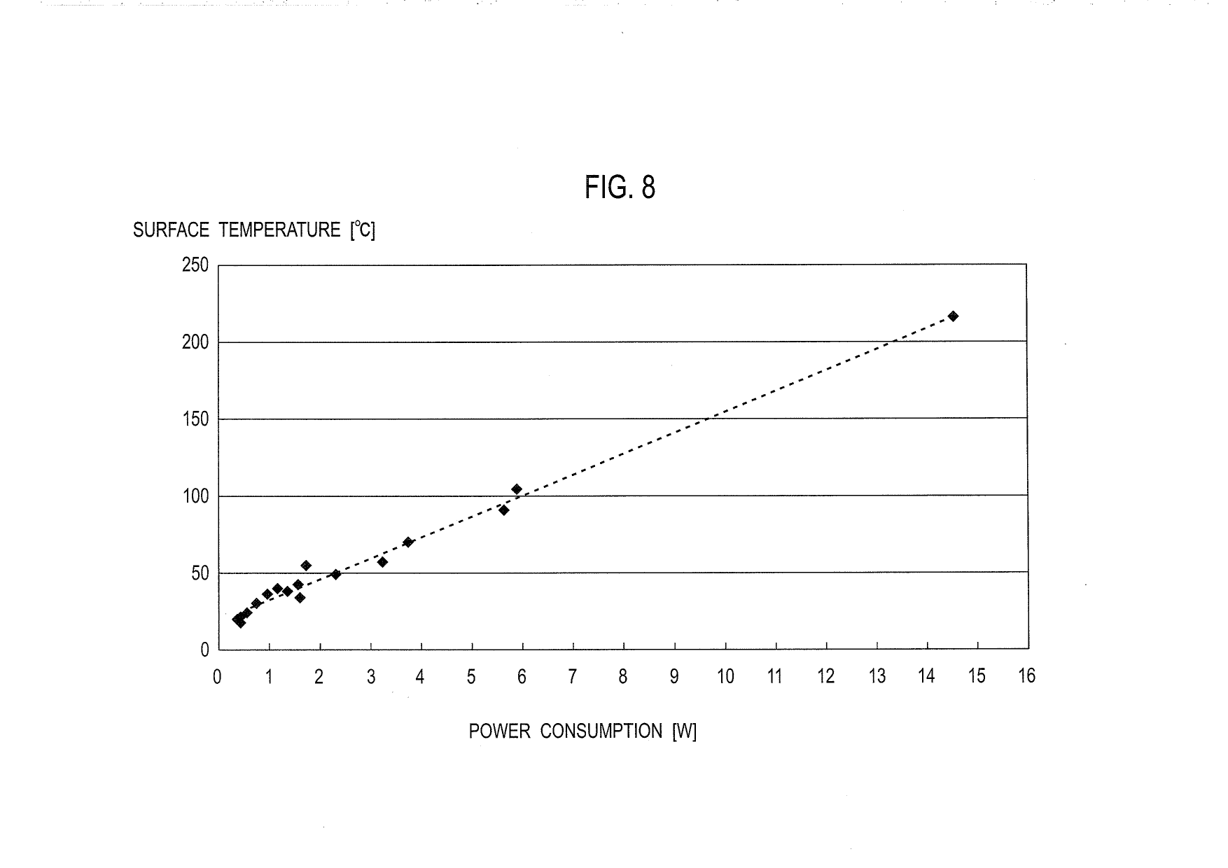

FIG. 7 is a table showing results of measuring the current, power consumption, and surface temperature when a voltage is applied to the heating yarns 3a (3b) each of which has the carbon fibers 15 having different resistances per unit length. FIG. 8 is a graph showing the power consumption relative to the surface temperature of the heating yarns 3a (3b) obtained from the measurement results of FIG. 7. As shown in the above table and graph, a sufficient increase in temperature is obtained with small power consumption when using the heating yarns 3a, 3b made of the carbon fibers 15. A temperature of the heating ground fabric 1 in which the heating yarns 3a, 3b were knitted into a grid was higher than that of the heating yarn 3a or the heating yarn 3b which was used alone, when the same voltage and current are applied thereto. This is because, arranging the heating yarns 3a, 3b close to each other can heat each other, thus bringing about a synergy between heat accumulation of the protective sheet 2 and heat retention by the protective sheet 2.

As described above, in the planar heating body 20 according to the present embodiment, the heating ground fabric 1 is formed as an integrated knit structure (knit fabric) including the heating yarns 3a, 3b and the conductive yarn 4. Thus, time and effort for mounting afterward the heating yarns 3a, 3b and the copper wire 4 can be eliminated, thus bringing about an excellent productivity. Further, the heating yarns 3a, 3b and the copper wire 4 are intertwined with the ground yarn 11, insert yarns 12, 14. Therefore, it gives an excellent durability, and prevents themselves from coming off or being deviated. Further, when covered with the protective sheet 2, the heating ground fabric 1 is further improved in durability, also bringing about an effect of uniform temperature as well as improved heat retention.

Further, the planar heating body 20 may include the heating ground fabric 1 having the heating yarn 3a only. Specifically, the knitting of the heating yarn 3b may be omitted. In this case as well, since the planar heating body 20 is formed as an integrated knit structure (knit fabric) including the heating yarn 3a and the conductive yarn 4, the same effect as the above can be brought about.

When the heating yarns 3a, 3b are knitted into the heating ground fabric 1 in the longitudinal direction and lateral direction, it is possible to efficiently and rapidly increase the temperature of the entirety of the planar heating body 20. Further, even when the heating yarn 3a in the lateral direction is broken, the current flows also through the broken heating yarn 3a by way of the heating yarn 3b in the longitudinal direction arranged in such a manner as to intersect with the heating yarn 3a, thus minimizing the portion which does not heat. Further, the heating ground fabric 1 is knitted into the net shape having the voids 5 between the heating yarns 3a, 3b, thus enabling to contribute to making the heating ground fabric 1 lighter and suppressing the production cost. The pitch-based carbon fiber 15 is used for the heating yarns 3a, 3b and the resistance of the heating yarns 3a, 3b is set to 50 Ω/m to 1000 Ω/m, thus realizing a high-performance planar heating body which is excellent in durability and has high heating efficiency as well as low power consumption.

The present invention is not limited to the embodiment described above. The knit patterns P1, P2, P3, and P4 of the heating ground fabric 1 can be properly changed. Further, types and materials of the heating yarns 3a, 3b, conductive yarn 4, ground yarn 11 and insert yarns 12, 13, 14 may be properly changed. For example, with respect to the conductive yarn 4, besides the copper wire, one made by plating a metal such as copper to a synthetic fiber such as nylon can be used.

The planar heating body according to the present invention can be used as a heat retention instrument. In this case, for example, the planar heating body is attached to a seat face of a chair or embedded into a cushion, a blanket, clothes or the like. Further, the planar heating body can be used as a floor heater of a residential house, an outdoor snow-melting unit or the like. As described above, it is not necessarily required to cover the heating ground fabric 1 with the protective sheet 2. Therefore, the heating ground fabric 1 itself can be directly embedded into the seat or the like of a chair. The heating yarn may be any yarn that is heated by energizing, and may be made of a carbon fiber other than pitch-based (for example, PAN (polyacrylonitrile) carbon fiber).

### INDUSTRIAL APPLICABILITY

According to the present invention, a planar heating body excellent in productivity and durability can be provided.

1. A planar heating body comprising:
a knit structure;
a plurality of first heating yarns knitted into the knit structure in a lateral direction at intervals in a longitudinal direction;
a plurality of conductive yarns knitted into an edge section on each of both sides of the knit structure in the lateral direction, the conductive yarns being knitted thereinto in the longitudinal direction; and
a plurality of second heating yarns knitted in the longitudinal direction in such a manner as to intersect with the first heating yarns.

2. (canceled)

3. The planar heating body according to claim 1 wherein the first heating yarns and the second heating yarns are so knitted in a form of a net as to have voids between the first heating yarns and between the second heating yarns.

4. The planar heating body according to claim 1 wherein the first heating yarns are made of a carbon fiber having a resistance of 50 Ω/m to 1000 Ω/m.

5. The planar heating body according to claim 1 wherein the second heating yarns are made of a carbon fiber having a resistance of 50 Ω/m to 1000 Ω/m.

6. The planar heating body according to claim 1, further comprising:
a sheet made of a resin or a rubber, the sheet covering an entirety of the knit structure.

7. (canceled)
